(19) United States
(12) Patent Application Publication
(10) Pub. No.: US 2026/0320383 A1
(43) Pub. Date: Oct. 15, 2026

(54) SHARED LATENT REPRESENTATIONS OF MULTIMODAL DATASETS

(71) Applicant: Altos Labs, Inc., Redwood City, CA (US)

(72) Inventors: Daniel MONTEMAYOR, San Diego, CA (US); Kyra Leigh THRUSH, San Diego, CA (US); Cyril Oscar LAGGER, San Diego, CA (US); Margarita MEER, San Diego, CA (US); Morgan Elyse LEVINE, San Diego, CA (US); Henry Elvis Leroy MILLER, San Diego, CA (US)

(21) Appl. No.: 19/482,700

(22) PCT Filed: May 3, 2024
(86) PCT No.: PCT/US2024/027864

§ 371 Date: Nov. 7, 2025

Related U.S. Application Data
(63) Continuation of application No. 18/315,172, filed on May 10, 2023, now abandoned.

(51) Int. Cl. G06N 3/08

(52) U.S. Cl. CPC G06N 3/08

(57) ABSTRACT

One embodiment of the present invention sets forth a technique for determining a latent space between two or more domains. The technique includes executing a first generator neural network to convert a first set of training data associated with a first domain into a first set of training outputs based on a first set of latent values associated with the first domain. The technique also includes executing a second generator neural network to convert the first set of training outputs into a second set of training outputs based on a second set of latent values associated with the second domain. The technique further includes training the first generator neural network based on a first set of losses computed between the first set of latent values and the second set of latent values.

### CROSS-REFERENCE TO RELATED APPLICATIONS

This application claims priority benefit of United States Patent Application titled “SHARED LATENT REPRESENTATIONS OF MULTIMODAL DATASETS,” Ser. No. 18/315,172, filed May 10, 2023. The subject matter of this related application is hereby incorporated herein by reference.

### BACKGROUND

### Field of the Various Embodiments

Embodiments of the present disclosure relate generally to machine learning and, more specifically, to determining shared latent representations of both paired and unpaired multimodal datasets.

### Description of the Related Art

Biological systems exhibit various complex phenomena that affect and/or reflect broader attributes such as health, aging, resilience, and/or responses to interventions or treatments. Recently, a variety of techniques have been developed to collect and analyze biological data for the purposes of understanding the rules or mechanisms that underly these phenomena and/or attributes. For example, imaging techniques, such as Cryoelectron tomography (CryoET), can be used to produce high-resolution three-dimensional (3D) views of biological samples such as cells, tissues, organisms, or macromolecules. In another example, various “omics” disciplines can be used to study biological molecules that represent the structure, function, and dynamics of a biological system. Within these “omics” disciplines, genomics involves the study of the complete set of deoxyribonucleic acid (DNA) within an biological system (e.g., an organism), proteomics can be used to characterize proteins produced or modified by the biological system, transcriptomics involves the study of ribonucleic acid (RNA) molecules transcribed from the genome of a biological system, metabolomics can involves the study of small-molecule metabolites within a biological system, epigenomics involves the study of epigenetic modifications to the genetic material of a biological system, phenomics involves the study of observable characteristics or traits of a biological system, and metagenomics can be used to study genetic material recovered from environmental samples.

However, it can be difficult to determine or characterize patterns or relationships across large biological datasets that are generated using different techniques. More specifically, each type of biological data can provide a noisy and incomplete view of the state or functioning of a biological system. At the same time, physiological, functional, imaging, and/or other types of biological data can be difficult to relate to one another unless a single assay is used to collect these types of data from a single biological sample.

As the foregoing illustrates, what is needed in the art are more effective techniques for analyzing and coalescing data across different biological domains.

### SUMMARY

One embodiment of the present invention sets forth a technique for determining a latent space between two domains. The technique includes executing a first generator neural network to convert a first set of training data associated with a first domain into a first set of training outputs based on a first set of latent values associated with the first domain. The technique also includes executing a second generator neural network to convert the first set of training outputs into a second set of training outputs based on a second set of latent values associated with the second domain. The technique further includes training the first generator neural network based on a first set of losses computed between the first set of latent values and the second set of latent values.

One technical advantage of the disclosed techniques relative to the prior art is that the shared latent space learned by the first and second generator neural networks allows disparate types of data to be related to one another in a semantically meaningful manner. Accordingly, the disclosed techniques provide a more complete view of a biological system (or another type of entity) that is represented using these types of data than conventional machine learning techniques that are not capable of generating shared latent spaces across multiple biological (or other types of) domains. Another technical advantage of the disclosed techniques is the ability to train the first and second generator neural networks to learn the shared latent space in the absence of paired training data from different domains. Consequently, the disclosed techniques can use a larger set of data to generate a more complete and semantically meaningful shared latent space than prior art approaches that use paired data to learn latent spaces associated with multiple domains. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is a more detailed illustration of the training engine and execution engine of FIG. 1, according to various embodiments.

FIG. 3 illustrates the operation of the training engine of FIG. 1 in training two generators to learn a latent space that is shared by two domains, according to various embodiments.

FIG. 4 illustrates an example use of a shared latent space to perform operations associated with data from a first domain and data from a second domain, according to various embodiments.

FIG. 5 is a flow diagram of method steps for training a machine learning model to learn a shared latent space between multiple domains, according to various embodiments.

FIG. 6 is a flow diagram of method steps for analyzing data associated with multiple domains, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

As discussed above, data from a given biological domain can be noisy and provide an incomplete picture of the overall health, state, or function of a biological system. At the same time, it can be difficult to relate different types of biological data to one another and/or to the underlying health, state, or function of a biological system especially without collecting the biological data from a single biological sample during a single assay.

To improve the understanding of biological data and/or other types of data across multiple domains, the disclosed techniques train and execute a machine learning model to generate a shared latent representation of a multimodal dataset. The machine learning model includes multiple encoders and multiple decoders. Each encoder converts data from a corresponding domain into a fixed-length latent representation within a lower-dimensional latent space. Each decoder converts a latent representation from the lower-dimensional latent space into data in a corresponding domain. A given encoder can be paired with a decoder for the same domain to form a generator that is capable of reconstructing data in the domain. A given encoder for a first domain can also, or instead, be paired with a decoder for a second domain to form a generator that is capable of converting data in the first domain into data in the second domain.

For example, the machine learning model could include one or more encoders that convert samples from image-based data, sequencing-based data, omics data, physiological data, data collected from steady state cells, data collected from perturbed cells, data from a young system, data from an older system, and/or other types of biological data into corresponding latent values. The machine learning model could also include one or more decoders that convert each latent value into one or more samples from the same domains and/or different domains. In this example, an encoder for image-based data could be paired with a decoder for image-based data to convert the image-based data into latent representations and to reconstruct the image-based data from the latent representations. The encoder for image-based data could be paired with a different decoder for sequencing-based data to convert between image-based data and sequencing-based data, compare image-based data with sequencing-based data, and/or perform other analyses or predictions related to the image-based data and/or sequencing-based data.

To train the machine learning model, a first encoder for the first domain is used to convert the training data into a first set of latent values. A first decoder for a second domain is used to convert the first set of latent values into a first set of training output. A second encoder for the second domain is used to convert the first set of training output into a second set of latent values. A second decoder for the first domain is used to convert the second set of latent values into a second set of training output. The encoders and decoders are trained using a number of losses that are computed using the first and second sets of latent values, the first and second sets of training output, and/or output generated by one or more discriminator models from the latent values and/or training output. These losses can be used to ensure that at least a portion of the latent space occupied by the latent values is invariant to the domains from which the latent values were derived.

When a shared latent space is to be learned across more than two domains, encoders and decoders for the various domains can be trained in a “daisy chain” fashion. For example, during a first training stage, a first encoder and a first decoder for a first domain and a second encoder and a second decoder for a second domain could be trained using the technique described above to learn a shared latent space between the two domains. During a second training stage, a third encoder for a third domain could be paired with the first and/or second decoder, and a third decoder for the third domain could be paired with the first and/or second encoder. The same training technique could be repeated using the new encoder-decoder pairs so that the latent space associated with the third domain is shared with the latent spaces of the first and second domains. Additional training stages could further be added to extend the shared latent space to additional domains.

### System Overview

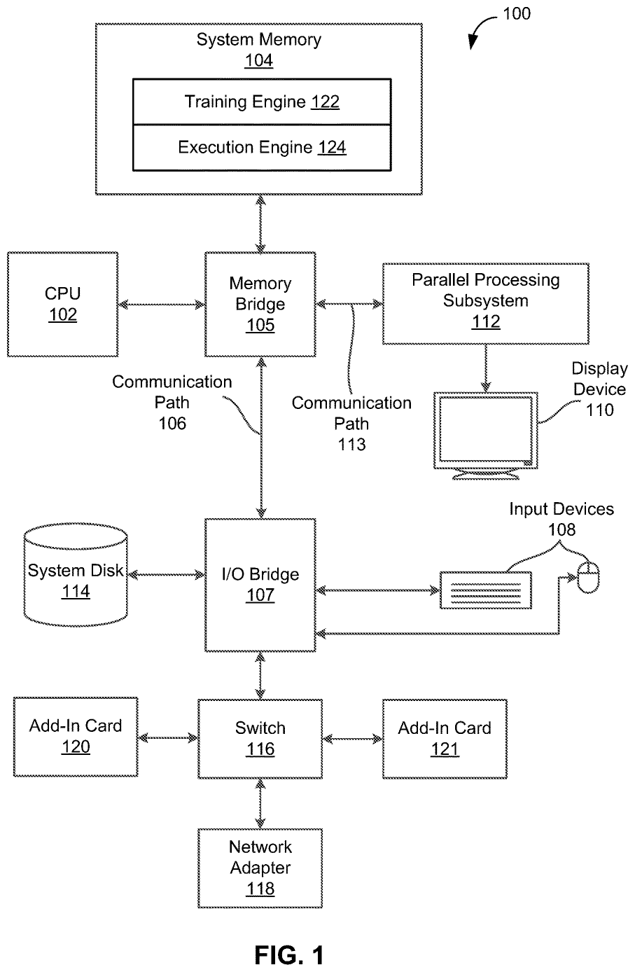

FIG. 1 is a block diagram illustrating a computer system 100 configured to implement one or more aspects of various embodiments. In one embodiment, computer system 100 includes a desktop computer, a laptop computer, a smart phone, a personal digital assistant (PDA), tablet computer, or any other type of computing device configured to receive input, process data, and optionally display images, and is suitable for practicing one or more embodiments. Computer system 100 also, or instead, includes a machine or processing node operating in a data center, cluster, or cloud computing environment that provides scalable computing resources (optionally as a service) over a network.

As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via the network adapter 118. In one embodiment, switch 116 is configured to provide connections between I/O bridge 107 and other components of the computer system 100, such as a network adapter 118 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), Hyper Transport, or any other bus or point-to-point communication protocol known in the art.

In some embodiments, parallel processing subsystem 112 includes a graphics subsystem that delivers pixels to an optional display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. Such circuitry may be incorporated across one or more parallel processing units (PPUs), also referred to herein as parallel processors, included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver configured to manage the processing operations of the one or more PPUs within parallel processing subsystem 112.

Parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. First, the functionality of the system can be distributed across multiple nodes of a distributed and/or cloud computing system. Second, the connection topology, including the number and arrangement of bridges, the number of CPUs 102, and the number of parallel processing subsystems 112, can be modified as desired. For example, in some embodiments, system memory 104 could be connected to CPU 102 directly rather than through memory bridge 105, and other devices would communicate with system memory 104 via memory bridge 105 and CPU 102. In another example, parallel processing subsystem 112 may be connected to I/O bridge 107 or directly to CPU 102, rather than to memory bridge 105. In a third example, I/O bridge 107 and memory bridge 105 may be integrated into a single chip instead of existing as one or more discrete devices. Third one or more components shown in FIG. 1 may not be present. For example, switch 116 could be eliminated, and network adapter 118 and add-in cards 120, 121 would connect directly to I/O bridge 107.

In one or more embodiments, computer system 100 is configured to execute a training engine 122 and an execution engine 124 that reside in system memory 104. Training engine 122 and execution engine 124 may be stored in system disk 114 and/or other storage and loaded into system memory 104 when executed.

More specifically, training engine 122 and execution engine 124 include functionality to train and execute a machine learning model to learn a shared latent representation of data across multiple domains. For example, training engine 122 and execution engine 124 could be used to generate a machine learning model that converts between data samples in image-based data, sequencing-based data, omics data, physiological data, data collected from steady state cells, data collected from perturbed cells, data from a young system, data from an older system, and/or other types of biological data and latent values in a shared lower-dimensional latent space.

The machine learning model includes multiple generator neural networks that are trained with multiple discriminator neural networks using a Cycle Generative Adversarial Network (CycleGAN) paradigm. During training of the machine learning models, the discriminator neural networks are used to classify latent values and/or generative output from the generator neural networks. This classification output from the discriminator neural networks is also used to update the parameters of the generator neural networks so that latent values produced by the generator neural networks for different domain reside in the same shared latent space. The operation of training engine 122 and execution engine 124 is described in further detail below.

### Shared Latent Representations of Multimodal Datasets

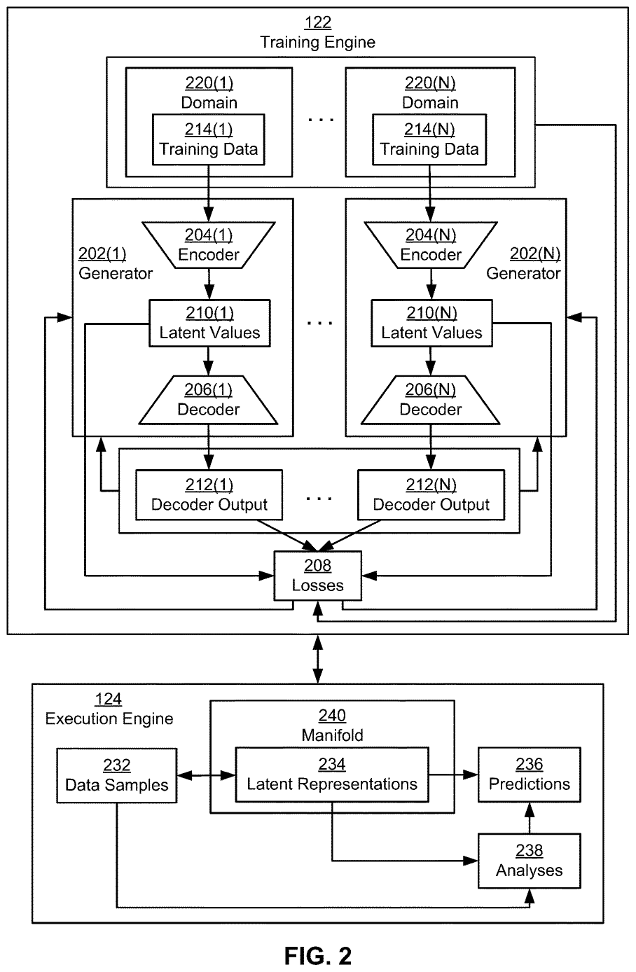

FIG. 2 is a more detailed illustration of training engine 122 and execution engine 124 of FIG. 1, according to various embodiments. As mentioned above, training engine 122 and execution engine 124 operate to train and execute a machine learning model to learn a latent manifold 240 that is shared by data samples 232 from multiple domains 220(1)-220(N) (each of which is referred to individually herein as domain 220).

In some embodiments, domains 220 represent different types of biological data samples that can be collected or generated from a biological system. For example, domains 220 could represent (but are not limited to) image-based data, sequencing-based data, omics data, physiological data, data collected from steady state cells, data collected from perturbed cells, data from biological systems of different ages, data collected via medical scanning techniques, and/or other types of biological data.

In various embodiments, the data samples can be generated by any number of data generation steps, such as imaging, sequencing,-omics measurements, and generative machine learning. Examples of imaging techniques include light microscopy or cryogenic electron microscopy. Examples of-omics measurements include transciptomics (e.g., RNAseq), genomics, proteomics, metabolomics, and epigenomics (e.g., ATACseq, DNA methylation). Further, the data samples may be perturbed in a variety of ways. Examples of perturbations include (i) environmental stimuli, such as temperature change, osmotic shock, pressure change, stress, starvation, (ii) perturbation with chemical, pharmaceutical, or biologic agent, (iii) manipulation of gene function, such as gene knockout (e.g., CRISPR knockout), transcript knockdown, or CRISPR alteration.

Domains 220 can also, or instead, represent other types of data. For example, domains 220 could include text, images, audio, video, point clouds, meshes, sensor data, and/or other types of data associated with users, objects, environments, computer systems, machinery, virtual worlds, and/or other types of entities.

As shown in FIG. 2, the machine learning model includes multiple generators 202(1)-202(N). Generator 202(1) includes an encoder 204(1) and a decoder 206(1), and generator 202(N) includes a separate encoder 204(N) and decoder 206(N). Each encoder 204(1)-204(N) converts a set of input into a corresponding set of latent values 210(1)-210(N), and each decoder 206(1)-206(N) converts a given set of latent values 210(1)-210(N) into a corresponding set of decoder output 212(1)-212(N). Each of generators 202(1)-202(N) is referred to individually herein as generator 202, each of encoders 204(1)-204(N) is referred to individually as encoder 204, and each of decoder 206(1)-206(N) is referred to individually as decoder 206. Each set of latent values 210(1)-210(N) is referred to individually herein as latent values 210, and each set of decoder output 212(1)-212(N) is referred to individually herein as decoder output 212.

In some embodiments, encoders 204 and decoders 206 include residual neural networks with rectified linear unit (ReLU) activation functions, dropout layers, and normalization layers. The last layer of one or more encoders 204 and/or one or more decoders 206 can include a tanh activation function. Encoders 204 and decoders 206 can also, or instead, include other types of neural network architectures. For example, encoders 204 and/or decoder 206 could include diffusion models, domain invariant variational autoencoders (DIVAs), model-based autoencoders for generating discrete omics samples with known statistical properties, and/or other types of neural networks that are capable of converting between data samples in one or more domains and latent values in a latent space.

Training engine 122 trains generators 202 using multiple sets of training data 214(1)-214(N) (each of which is referred to individually as training data 214). As shown in FIG. 2, each set of training data 214 is associated with a different domain 220. For example, a set of training data 214 for a given domain 220 could include (but is not limited to) image-based data generated using a specific imaging or scanning technique, sequencing-based data generated using a specific technique and/or for a specific type of organism, a specific type of omics data, a specific type of physiological data, data collected from a specific type of steady state cell, data collected from cells that have been perturbed in a specific way, data from a biological system of a certain age, and/or another distribution of data that is generated in a certain manner and/or collected from a certain source (e.g., an organism or a type of organism).

More specifically, training engine 122 trains each generator 202 using training data 214 from one or more domains 220. During training of a given generator 202, training engine 122 inputs training data 214 associated with one domain 220 into encoder 204 within that generator 202 and uses encoder 204 to convert the inputted training data 214 into a set of latent values 210. Training engine 122 also uses decoder 206 within that generator 202 to convert the set of latent values 210 into a corresponding set of decoder output 212. Training engine 122 computes one or more losses 208 using training data 214, latent values 210, and/or decoder output 212 and uses a training technique (e.g., gradient descent and backpropagation) to update parameters of encoders 204 and decoders 206 within generators 202 in a way that reduces losses 208.

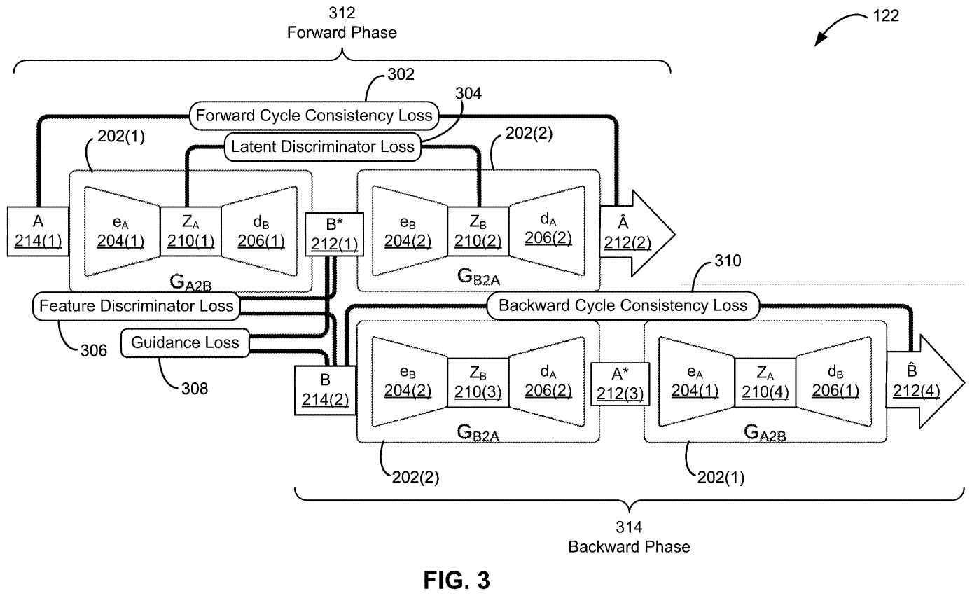

FIG. 3 illustrates the operation of training engine 122 of FIG. 1 in training two generators 202(1) and 202(2) to learn a latent space that is shared by two domains 220, according to various embodiments. As shown in FIG. 3, one domain 220 is denoted by A and another domain 220 is denoted by B. One generator 202(1) is denoted by G_{A2B} and includes an encoder 204(1) that is denoted by e_{A} and a decoder 206(1) denoted by d_{B}. Within generator 202(1), the e_{A} encoder 204(1) converts data in domain A into latent representations within a latent space denoted by Z_{A}. The de decoder 206(1) converts latent representations within the Z_{A} latent space into data in domain B. Thus, generator 202(1) can be used to convert data from domain A into data in domain B.

Another generator 202(2) is denoted by G_{B2A} and includes an encoder 204(2) denoted by e_{B} and a decoder 206(2) denoted by d_{A}. Within generator 202(2), the e_{B} encoder 204(2) converts data in domain B into latent representations within a latent space denoted by Z_{B}. The da decoder 206(1) converts latent representations within the Z_{B} latent space into data in domain A. Consequently, generator 202(2) can be used to convert data from domain B into data in domain A.

In one or more embodiments, training engine 122 trains generators 202(1) and 202(2) in a forward phase 312 and a backward phase 314. During forward phase 312, training engine 122 inputs training data 214(1) from domain A into encoder 204(1) of generator 202(1) and uses encoder 204(1) to convert training data 214(1) into a first set of latent values 210(1) in the Z_{A} latent space. Training engine 122 inputs latent values 210(1) into decoder 206(1) of generator 202(1) and uses decoder 206(1) to convert the first set of latent values 210(1) into a first set of decoder output 212(1) denoted by B*. Training engine 122 then inputs decoder output 212(1) into encoder 204(2) of generator 202(2) and uses encoder 204(2) to convert decoder output 212(1) into a second set of latent values 210(2) in the Z_{B} latent space. Training engine 122 inputs latent values 210(2) into decoder 206(2) of generator 202(2) and uses decoder 206(2) to convert latent values 210(2) into a second set of decoder output 212(2) denoted by Â.

Training engine 122 additionally trains generators 202(1)-202(2) using a number of losses (e.g., losses 208 of FIG. 2) that are computed based on training data 214(1), latent values 210(1)-210(2), and decoder output 212(1)-212(2). These losses include a forward cycle consistency loss 302 and a latent discriminator loss 304.

In some embodiments, forward cycle consistency loss 302 represents a measure of differences between training data 214(1) in domain A and decoder output 212(2) that corresponds to a reconstruction of training data 214(1) in the same domain. For example, forward cycle consistency loss 302 could include a mean squared error (MSE), mean absolute error (MAE), and/or another type of reconstruction loss between training data 214(1) and decoder output 212(2). In another example, decoder output 212(2) could include the parameters of a distribution from which generated data can be sampled, and forward cycle consistency loss 302 could be computed based on the likelihood of the training data coming from the distribution specified by decoder output 212(2).

Latent discriminator loss 304 is computed using output generated by a first discriminator neural network (not shown) from the two sets of latent values 210(1) and 210(2). More specifically, the first discriminator neural network includes a classifier that attempts to classify a given latent value as belonging to the Z_{A} latent space or to the Z_{B} latent space. Latent discriminator loss 304 can thus include a binary cross-entropy loss and/or another type of classification loss that is computed using correct and incorrect predictions of classes generated by the first discriminator neural network from both sets of latent values 210(1)-210(2).

After forward phase 312 is complete, training engine 122 performs backward phase 314. During backward phase 314, training engine 122 inputs training data 214(2) from domain B into encoder 204(2) of generator 202(2) and uses encoder 204(2) to convert training data 214(2) into a third set of latent values 210(3) in the ZB latent space. Training engine 122 inputs latent values 210(3) into decoder 206(2) of generator 202(2) and uses decoder 206(2) to convert the third set of latent values 210(3) into a third set of decoder output 212(3) denoted by A*. Training engine 122 then inputs decoder output 212(3) into encoder 204(1) of generator 202(1) and uses encoder 204(1) to convert decoder output 212(3) into a fourth set of latent values 210(4) in the Z_{A} latent space. Training engine 122 inputs latent values 210(4) into decoder 206(1) of generator 202(1) and uses decoder 206(1) to convert latent values 210(4) into a fourth set of decoder output 212(1) denoted by B.

Training engine 122 also trains generators 202(1)-202(2) using a backward cycle consistency loss 310 that is computed based on training data 214(2) in domain B and decoder output 212(4) that corresponds to a reconstruction of training data 214(2) in the same domain. As with forward cycle consistency loss 302, backward cycle consistency loss 310 can include an MSE, MAE, likelihood-based loss, and/or another type of loss that is computed using training data 214(2) and decoder output 212(4).

As shown in FIG. 3, training engine 122 additionally trains generators 202(1)-202(2) using a feature discriminator loss 306 and a guidance loss 308, which are computed using decoder output 212(1) generated during forward phase 312 and training data 214(2) inputted into generator 202(2) at the beginning of backward phase 314. Feature discriminator loss 306 is computed using features generated from decoder output 212(1) and training data 214(2). For example, training engine 122 could use an embedding model to convert decoder output 212(1) and training data 214(2) into corresponding sets of features. Training engine 122 could also use a second discriminator neural network (not shown) to classify a given set of features as belonging to real data or fake data in domain B. Training engine 122 could then compute feature discriminator loss 306 as a binary cross entropy loss, least squares loss, and/or another type of classification loss that is computed based on correct and incorrect predictions generated by the second discriminator neural network from decoder output 212(1) and training data 214(2).

In some embodiments, training engine 122 uses guidance loss 308 to mitigate mode collapse in generator 202(1), in which decoder output 212(1) produced by generator 202(1) fails to reflect the full distribution of data in domain B. For example, training engine 122 could use a clustering technique to group training data 214(2) in domain B into multiple clusters. Training engine 122 could also train a classifier to predict the cluster to which a given sample of data from domain B belongs. Training engine 122 could use the classifier to generate predictions of clusters for a batch of decoder output 212(1) and compute a loss that is inversely proportional to the “diversity” of clusters predicted by the classifier for the batch of decoder output 212(1). Consequently, training engine 122 could use the loss computed from the output from the classifier to ensure that generator 202(1) is capable of generating all modes in the distribution of data from domain B.

In another example, training engine 122 could use an implicit maximum likelihood estimation (IMLE) technique to minimize the distance between real samples from training data 214(2) and fake decoder output 212(1) produced by generator 202(1). The IMLE technique could involve selecting a random batch of decoder output 212(1) from generator 202(1) and updating the parameters of generator 202(1) so that the selected decoder output 212(1) samples are moved toward the nearest real data points in training data 214(2).

In one or more embodiments, training engine 122 performs training of encoders 204, decoders 206, and/or generators 202 using an overall loss that is computed as a weighted combination of forward cycle consistency loss 302, latent discriminator loss 304, feature discriminator loss 306, guidance loss 308, and backward cycle consistency loss 310. Weights used in the weighted combination can reflect the relative contributions of forward cycle consistency loss 302, latent discriminator loss 304, feature discriminator loss 306, guidance loss 308, and backward cycle consistency loss 310 to the overall loss. For example, training engine 122 could compute the overall loss using weights of 1.0 for both forward cycle consistency loss 302 and backward cycle consistency loss 310, 0.01 for feature discriminator loss 306, 0.005 for latent discriminator loss 304, and 0.01 for guidance loss 308. These weights can be adjusted to reflect different types of domains 220, latent space dimensions, neural network architectures for encoders 204 and decoders 206, and/or other factors. After the overall loss is computed, training engine 122 could backpropagate the overall loss across layers of generators 202(1) and/or 202(2) and use stochastic gradient descent to update parameters (e.g., neural network weights) of one or more components of generators 202(1) and/or 202(2) based on the negative gradients on the backpropagated loss.

Training engine 122 can also, or instead, train different generators 202(1) and/or 202(2) and/or different components of generators 202(1) and/or 202(2) using different losses and/or combinations of losses. For example, training engine 122 could train encoders 204(1)-204(2) and the discriminator neural network associated with latent values 210(1)-210(2) using latent discriminator loss 304. Training engine 122 could also, or instead, train generators 202(1) and/or 202(2) in an end-to-end fashion using forward cycle consistency loss 302 and backward cycle consistency loss. Training engine 122 could also, or instead, train generator 202(1) and discriminator neural networks associated with decoder output 212(1) and training data 214(2) using feature discriminator loss 306 and guidance loss 308.

This training of encoders 204, decoders 206, and/or generators 202 using forward cycle consistency loss 302, latent discriminator loss 304, feature discriminator loss 306, guidance loss 308, and backward cycle consistency loss 310 allows encoders 204, decoders 206, and/or generators 202 to learn a shared latent manifold within which latent values 210(1)-210(4) associated with different domains 220 lie. This shared latent manifold allows states associated with biological systems and/or other entities represented by data points in domains 220 to be determined, compared, and/or analyzed, as described in further detail below.

Training engine 122 additionally includes functionality to perform additional training of generators 202(1)-202(2) using variations of forward phase 312 and backward phase 314. For example, training engine 122 could perform one stage of training that includes forward phase 312 and backward phase 314 using the configurations of generators 202(1) and 202(2) shown in FIG. 3. Training engine 122 could also, or instead, perform a different or additional stage of training that includes a modified forward phase and a modified backward phase. The modified forward phase could involve using generator 202(2) to convert training data 214(2) from domain B into decoder output 212(3) in domain A, followed by using generator 202(1) to convert decoder output 212(3) into additional decoder output 212(4) in domain B. The modified backward phase could involve using generator 202(1) to convert training data 214(1) from domain A into decoder output 212(1) in domain B, followed by using generator 202(2) to convert decoder output 212(1) into additional decoder output 212(2) in domain A. During the modified forward phase and modified backward phase, training engine 122 could compute feature discriminator loss 306 using a different discriminator neural network that attempts to distinguish between training data 214(1) and decoder output 212(3). During the modified forward phase and modified backward phase, training engine 122 could also compute guidance loss 308 using training data 214(1) and decoder output 212(3).

In another example, training engine 122 could perform a given forward phase 312 and/or backward phase 314 multiple times. During a given round of forward phase 312 and/or backward phase 314, training engine 122 could train one encoder 204 and one decoder 206 associated with one domain 220 while holding the other encoder 204 and decoder 206 associated with the other domain 220 fixed.

Training engine 122 could also, or instead, train one generator 202 while holding the other generator 202 fixed. After that round of forward phase 312 and/or backward phase 314 is complete (e.g., after a certain number of training iterations or epochs), training engine 122 could perform a subsequent round of forward phase 312 and/or backward phase 314, in which the components (e.g., one encoder 204, one decoder 206, and/or one generator 202) that were held fixed during the previous round are trained while the components that were trained during the previous round are held fixed.

In a third example, training engine 122 could perform a round of forward phase 312 and backward phase 314 in which one or more encoders 204, decoders 206, and/or generators 202 are trained while one or more discriminators used to generate latent discriminator loss 304 and/or feature discriminator loss 306 associated with these encoders 204, decoders 206, and/or generators 202 are held fixed. Training engine 122 could then perform a subsequent round of forward phase 312 and backward phase 314 in which encoders 204, decoders 206, and/or generators 202 that were trained in the previous round are held fixed and the discriminator(s) used to generate latent discriminator loss 304 and/or feature discriminator loss 306 associated with these encoders 204, decoders 206, and/or generators 202 are trained. Training engine 122 could continue alternating training of various components of generators 202 with training of discriminators associated with these components to maintain balance between the performance of encoders 204, decoders 206, and/or generators 202 and the performance of the corresponding discriminators.

While the operation of training engine 122 has been described above with respect to learning a shared latent space between two domains 220, it will be appreciated that training engine 122 can be used to extend the shared latent space to encompass more than two domains 220. For example, training engine 122 could train encoders 204 and decoders 206 for more than two domains 220 in a “daisy chain” fashion that involves multiple training stages. During a first training stage, training engine 122 could train a first encoder 204 and a first decoder 206 for a first domain 220 and a second encoder 204 and a second decoder 206 for a second domain 220 using the technique described above with respect to FIG. 3, so that a shared latent space between the two domains 220 is learned by the two encoders 204 and two decoders 206. During a second training stage, training engine 122 could pair a third encoder 204 for a third domain with 220 the first and/or second decoder 206 and pair a third decoder 206 for the third domain 220 with the first and/or second encoder 204. Training engine 122 could also repeat the same training technique using the new encoder-decoder pairs so that the latent space associated with the third domain 220 is shared with the latent spaces of the first and second domains 220. Training engine 122 could also repeat this process to extend the shared latent space to additional domains 220 beyond the third domain 220.

Returning to the discussion of FIG. 2, after training of generators 202 using training data 214 from multiple domains 220 and losses 208 is complete, execution engine 124 uses the shared manifold 240 of latent values 210 to perform additional analyses 238 and/or predictions 236 related to data samples 232 in some or all domains 220. As shown in FIG. 2, execution engine 124 can use one or more encoders 204 to convert data samples 232 from the corresponding domains 220 into latent representations 234 that lie within manifold 240. Execution engine 124 can also, or instead, use one or more decoders 206 to convert latent representations 234 in manifold 240 into data samples 232 in the corresponding domains 220. Execution engine 124 can also perform analyses 238 that compare latent representations 234 and/or data samples 232. Execution engine 124 can further use data samples 232, latent representations 234, and/or analyses 238 to generate predictions 236 related to latent representations 234 and/or data samples 232.

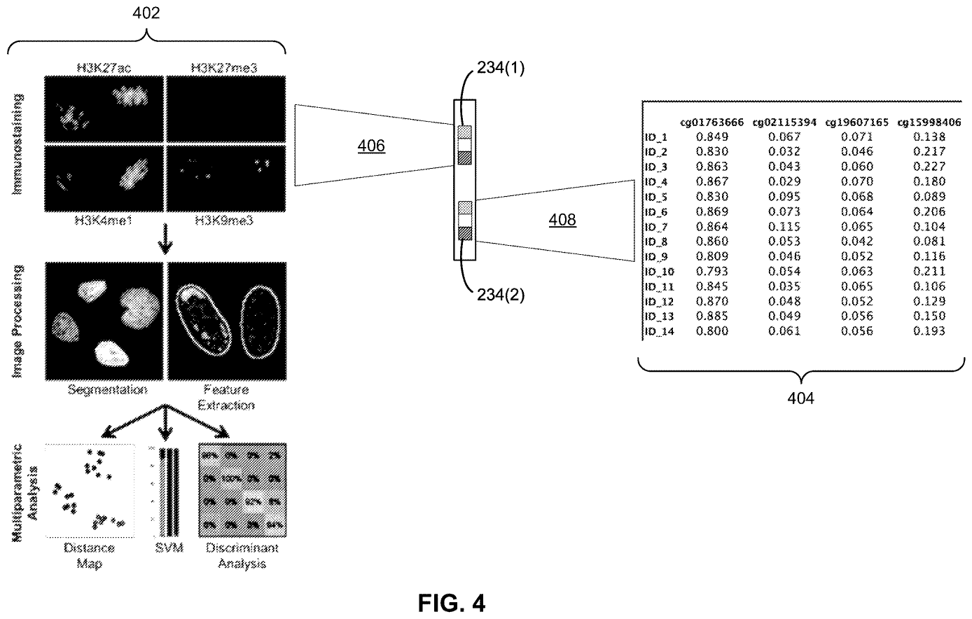

FIG. 4 illustrates an example use of a shared latent space to perform operations associated with data 402 from a first domain and data 404 from a second domain, according to various embodiments. As shown in FIG. 4, data 402 includes image-based data that can be generated via immunostaining, image processing, and multiparametric analysis techniques. Data 404 includes omics-based deoxyribonucleic acid (DNA) methylation data that can be generated using various sequencing techniques.

Data 402 and 404 can be compared with and/or converted into one another using components 406 and 408 that are included in one or more generators 202. For example, component 406 could include an encoder that is specific to the domain associated with data 402, and component 408 could include a decoder that is specific to the domain associated with data 404. Component 406 could be used to convert images, segmented objects within images, image-based features, and/or image-based analyses included in data 402 into a latent representation 234(1) in a shared latent space (e.g., manifold 240 of FIG. 2) associated with both domains. The value of latent representation 234(1) could be used as a corresponding latent representation 234(2) that is inputted into component 408. Component 408 could then be used to convert latent representation 234(2) into DNA methylation values corresponding to data 404.

In another example, component 406 could include an encoder that is specific to the domain associated with data 402, and component 408 could include an encoder that is specific to the domain associated with data 404. In this example, components 406 and 408 could be used to convert data 402 and 404, respectively, into respective latent representations 234(1) and 234(2) in the shared latent space. A cosine similarity, Euclidean distance, dot product, and/or another measure of vector similarity or distance could be computed between latent representations 234(1)-234(2) to determine the level of similarity or dissimilarity and/or a difference in state between biological systems represented by data 402 and 404. Additional points in the latent space that represent interpolations between latent representations 234(1) and 234(2) could also, or instead, be determined. Decoders for various domains associated with the shared latent space could then be used to convert the additional points into corresponding data points in those domains. These data points would represent states of biological systems that lie in between the state associated with data 402 and the state associated with data 404. The process could be repeated for additional pairs and/or sets of latent representations 234 to explore the shared latent space, determine biological states represented by latent representations 234 within the shared latent space, determine similarities and/or relationships between the biological states and/or the corresponding latent representations 234, and/or perform other types of operations or analyses related to latent representations 234, the corresponding sets of data, and/or biological systems represented by the data.

While the example of FIG. 4 illustrates the use of a shared latent space to perform analyses and/or predictions associated with image-based data 402 and DNA methylation data 404, it will be appreciated that the functionality of components 406 and 408 can be used to perform various types of analyses 238 and/or predictions 236 related to other domains. For example, components 406 and 408 could include encoders, decoders, and/or other elements of one or more generators 202 associated with image-based data, sequencing-based data, omics data, physiological data, data collected from steady state cells, data collected from perturbed cells, data from a young system, data from an older system, and/or other types of biological data. These generators 202 could also, or instead, be associated with text, images, audio, video, point clouds, meshes, sensor data, and/or other types of data generated by or collected from users, objects, environments, computer systems, machinery, virtual worlds, and/or other types of entities. These generators 202 could be used to convert between data points in the corresponding domains and latent representations 234 in the shared latent space, determine relationships or similarities between the data points, determine or predict states or attributes represented by the data points and/or latent representations 234, predict the response of a biological system and/or entity to aging and/or perturbations, predict disease and/or other risks for a biological system using data associated with multiple domains for the biological system, and/or perform other operations using the data points and/or latent representations.

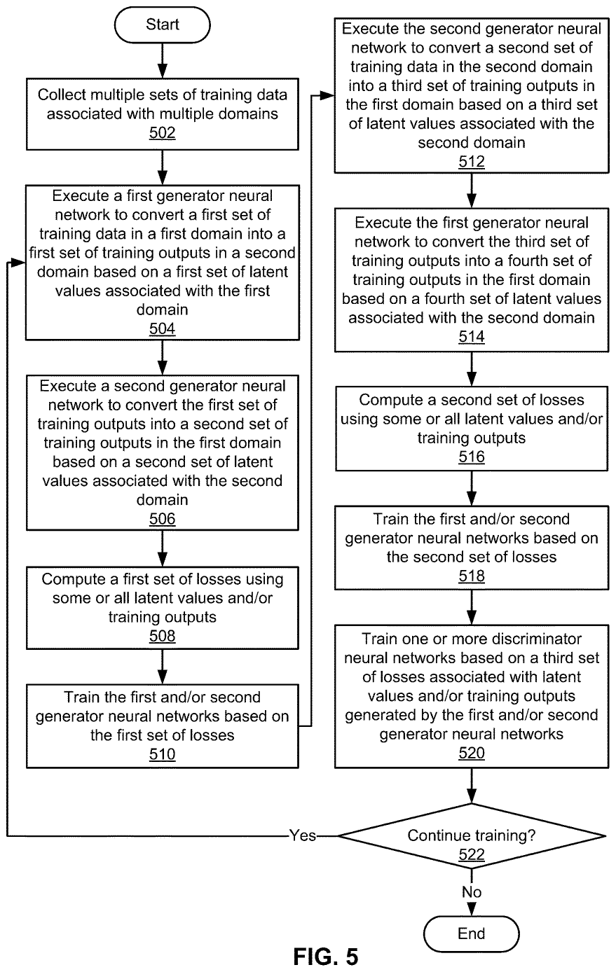

FIG. 5 is a flow diagram of method steps for training a machine learning model to learn a shared latent space between multiple domains, according to various embodiments. Although the method steps are described in conjunction with the systems of FIGS. 1-3, persons skilled in the art will understand that any system configured to perform some or all of the method steps in any order falls within the scope of the present disclosure.

As shown, in step 502, training engine 122 collects multiple sets of training data associated with multiple domains. For example, training engine 122 could collect image-based data, sequencing-based data, omics data, physiological data, data collected from steady state cells, data collected from perturbed cells, data from a young system, data from an older system, and/or other types of biological data. Training engine 122 could also, or instead, collect text, images, audio, video, point clouds, meshes, sensor data, and/or other types of data generated by or collected from users, objects, environments, computer systems, machinery, virtual worlds, and/or other types of entities. Training engine 122 could obtain each set of data from a repository, a streaming data source, a synthetic data generator, and/or another data source.

In step 504, training engine 122 executes a first generator neural network to convert a first set of training data in a first domain into a first set of training outputs in a second domain based on a first set of latent values associated with the first domain. For example, training engine 122 could use a first encoder within the first generator neural network to convert the inputted training data into a first set of latent values in a latent space associated with the first domain. Training engine 122 could also use a first decoder within the first generator neural network to convert the first set of latent values into the first set of training outputs.

In step 506, training engine 122 executes a second generator neural network to convert the first set of training outputs into a second set of training outputs in the first domain based on a second set of latent values associated with the second domain. Continuing with the above example, training engine 122 could use a second encoder within the second generator neural network to convert the first set of training outputs into a second set of latent values in a latent space associated with the second domain. Training engine 122 could also use a second decoder within the second generator neural network to convert the second set of latent values into the second set of training outputs.

In step 508, training engine 122 computes a first set of losses using some or all latent values and/or training outputs generated in the previous steps. For example, training engine 122 could compute a forward cycle consistency loss as a measure of differences between the first set of training data in the first domain and the second set of training outputs, which correspond to a reconstruction of the first set of training data. Training engine 122 could also, or instead, compute a latent discriminator loss using output generated by a first discriminator neural network from the two sets of latent values.

In step 510, training engine 122 trains the first and/or second generator neural networks based on the first set of losses. For example, training engine 122 could use gradient descent and backpropagation to update weights of the first and/or second generator neural networks in a way that reduces the forward cycle consistency loss, the latent discriminator loss, and/or a weighted combination of the forward cycle consistency loss and the latent discriminator loss.

In step 512, training engine 122 executes the second generator neural network to convert a second set of training data in the second domain into a third set of training outputs in the first domain based on a third set of latent values associated with the second domain. For example, training engine 122 could use the second encoder within the second generator neural network to convert the second set of training data into the third set of latent values in the latent space associated with the second domain. Training engine 122 could also use the second decoder within the second generator neural network to convert the third set of latent values into the third set of training outputs.

In step 514, training engine 122 executes the first generator neural network to convert the third set of training outputs into a fourth set of training outputs in the first domain based on a fourth set of latent values associated with the second domain. Continuing with the above example, training engine 122 could use the first encoder in the first generator neural network to convert the third set of training outputs into the fourth set of latent values in the latent space associated with the first domain.

Training engine could also use the first decoder in the first generator neural network to convert the fourth set of latent values into the fourth set of training outputs.

In step 516, training engine 122 computes a second set of losses using some or all latent values and/or training outputs generated in the previous steps. For example, training engine 122 could compute a backward cycle consistency loss as a measure of differences between the second set of training data in the second domain and the fourth set of training outputs, which correspond to a reconstruction of the second set of training data.

In another example, training engine 122 could use an embedding model to convert a given set of training output and a corresponding set of training data in the same domain into corresponding sets of features. Training engine 122 could also use a second discriminator neural network to classify a given set of features as real data or fake data in that domain. Training engine 122 could then compute a feature discriminator loss 306 as an adversarial loss and/or classification loss based on correct and incorrect predictions generated by the second discriminator neural network from the training output and training data.

In a third example, training engine 122 could use a clustering technique to group training data in a given domain into multiple clusters. Training engine 122 could train a classifier to predict the cluster to which a given sample of data from that domain belongs. Training engine 122 could use the classifier to generate predictions of clusters for a batch of decoder output 212(1) and compute a loss that is inversely proportional to the “diversity” of clusters predicted by the classifier for the batch of decoder output 212(1).

In a fourth example, training engine 122 could use an implicit maximum likelihood estimation (IMLE) technique to minimize the distance between real samples from a set of training data in a given domain and fake training outputs in the same domain that are produced by a generator neural network. The IMLE technique could involve selecting a random batch of training outputs from the generator neural network and computing a loss based on the distances between the selected training outputs and the nearest real data points in the set of training data.

In step 518, training engine 122 trains the first and/or second generator neural networks based on the second set of losses. For example, training engine 122 could compute an overall loss as a weighted combination of the forward cycle consistency loss, latent discriminator loss, feature discriminator loss, guidance loss, and/or backward cycle consistency loss. Training engine 122 could also update the parameters of the first and/or second generator neural networks in a way that reduces the overall loss.

In step 520, training engine 122 trains one or more discriminator neural networks based on a third set of losses associated with latent values and/or training outputs generated by the first and/or second generator neural networks. For example, training engine 122 could use the updated generator neural networks to generate additional latent values and training outputs from training data in the first and second domains. Training engine 122 could use a first discriminator neural network to classify the latent values as associated with the first domain or the second domain. Training engine 122 could compute a new latent discriminator loss using the classification output from the first discriminator neural network and train the first discriminator neural network based on the new latent discriminator loss. Training engine 122 could also, or instead, use a second discriminator neural network to classify data associated with a corresponding domain and/or features generated from the data as real or fake. Training engine 122 could compute a discriminator loss using the classification output and train the second discriminator neural network based on the discriminator loss.

In step 522, training engine 122 determines whether or not to continue training the generator and discriminator neural networks. For example, training engine 122 could determine that training of the generator and discriminator neural networks is to continue until one or more conditions are met. These condition(s) include (but are not limited to) convergence in the parameters of the generator and/or discriminator neural networks; the lowering of the loss(es) to below a threshold; or a certain number of training steps, iterations, batches, and/or epochs. Once these condition(s) are met, training engine 122 ends the process of training the generator and discriminator neural networks.

If training of the generator and discriminator neural networks is to continue, training engine 122 repeats steps 504-520 to further train the generator and discriminator neural networks. For example, training engine 122 could repeat steps 504-520 over multiple iterations to train different components of the generator and/or discriminator neural networks. During a given iteration, training engine 122 could train one generator neural network while holding the other generator neural network fixed. Training engine 122 could also, or instead, train an encoder and decoder associated with one domain while holding the other encoder and decoder associated with the other domain fixed. During the next iteration, training engine 122 could train the generator neural network (or encoder and decoder) that was held fixed in the previous iteration and hold the generator neural network (or encoder and decoder) that was trained in the previous iteration fixed.

In another example, training engine 122 could perform a first training stage that trains the first and second generator neural networks and the corresponding discriminator neural networks over a certain number of iterations of steps 504-520. Training engine 122 could then swap the first and second generator neural networks and perform a second training stage that trains the swapped generator neural networks and discriminator neural networks over an additional number of iterations of steps 504-520.

Training engine 122 can additionally repeat steps 504-520 to train additional generator and discriminator neural networks associated with additional domains. For example, after training of the first and second generator neural networks is complete, training engine 122 could create a new “first” generator neural network by pairing a third encoder for a third domain with the decoder in the first and/or second generator neural networks. Training engine 122 could also create a new “second” generator neural network by pairing a third decoder for the third domain with the encoder in the first and/or second generator neural network. Training engine 122 could also perform steps 504-522 one or more times using the new first and second generator neural networks (and corresponding discriminator neural networks) so that the latent space associated with the third domain is shared with the latent spaces of the first and second domains. Training engine 122 could continue adding new domains to the shared latent space in this manner until the shared latent space incorporates all domains associated with the training data collected in step 502 and/or domains associated with training data collected separately from step 502.

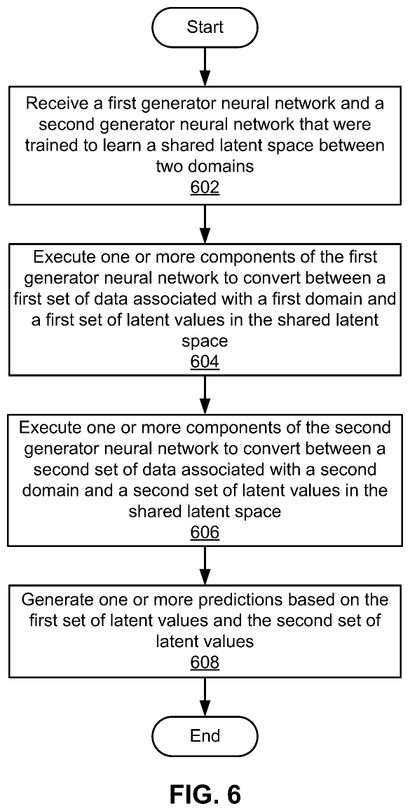

FIG. 6 is a flow diagram of method steps for analyzing data associated with multiple domains, according to various embodiments. Although the method steps are described in conjunction with the systems of FIGS. 1-3, persons skilled in the art will understand that any system configured to perform some or all of the method steps in any order falls within the scope of the present disclosure.

As shown, in step 602, execution engine 124 receives a first generator neural network and a second generator neural network that were trained to learn a shared latent space between two domains. For example, execution engine 124 could receive the first and second generator neural networks from training engine 122, a repository, and/or another source after the generator neural networks were trained using the steps discussed with respect to FIG. 5.

In step 604, execution engine 124 executes one or more components of the first generator neural network to convert between a first set of data associated with a first domain and a first set of latent values. For example, execution engine 124 could use an encoder in the first generator neural network to convert data points in the first domain into corresponding latent values. Execution engine 124 could also, or instead, use a decoder in the first generator neural network to convert latent values in a latent space into corresponding data points in the first domain.

In step 606, execution engine 124 executes one or more components of the second generator neural network to convert between a second set of data associated with a second domain and a second set of latent values. For example, execution engine 124 could use an encoder in the second generator neural network to convert data points in the second domain into corresponding latent values. Execution engine 124 could also, or instead, use a decoder in the second generator neural network to convert latent values in a latent space into corresponding data points in the second domain.

In step 608, execution engine 124 generates one or more predictions based on the first set of latent values and the second set of latent values. For example, execution engine 124 could use the first and second sets of latent values to determine similarities and/or other relationships between the corresponding data points, predict states and/or changes in state associated with the data points, convert a data point in one domain into a corresponding data point in the other domain, and/or perform other operations or analyses involving one or both domains.

In sum, the disclosed techniques train and execute a machine learning model to generate a shared latent representation of a multimodal dataset. The machine learning model includes multiple encoders and multiple decoders. Each encoder converts data from a corresponding domain into a fixed-length latent representation within a lower-dimensional latent space. Each decoder converts a latent representation from the lower-dimensional latent space into data in a corresponding domain. A given encoder can be paired with a decoder for the same domain to form a generator that is capable of reconstructing data in the domain. A given encoder for a first domain can also, or instead, be paired with a decoder for a second domain to form a generator that is capable of converting data in the first domain into data in the second domain.

For example, the machine learning model could include one or more encoders that convert samples from image-based data, sequencing-based data, -omics data, physiological data, data collected from steady state cells, data collected from perturbed cells, data from a young system, data from an older system, and/or other types of biological data into corresponding latent values. The machine learning model could also include one or more decoders that convert each latent value into one or more samples from the same domains and/or different domains. In this example, an encoder for image-based data could be paired with a decoder for image-based data to convert the image-based data into latent representations and to reconstruct the image-based data from the latent representations. The encoder for image-based data could be paired with a different decoder for sequencing-based data to convert between image-based data and sequencing-based data, compare image-based data with sequencing-based data, and/or perform other analyses or predictions related to the image-based data and/or sequencing-based data.

To train the machine learning model, a first encoder for the first domain is used to convert the training data into a first set of latent values. A first decoder for a second domain is used to convert the first set of latent values into a first set of training output. A second encoder for the second domain is used to convert the first set of training output into a second set of latent values. A second decoder for the first domain is used to convert the second set of latent values into a second set of training output. The encoders and decoders are trained using a number of losses that are computed using the first and second sets of latent values, the first and second sets of training output, and/or output generated by one or more discriminator models from the latent values and/or training output. These losses can be used to ensure that at least a portion of the latent space occupied by the latent values is invariant to the domains from which the latent values were derived.

When a shared latent space is to be learned across more than two domains, encoders and decoders for the various domains can be trained in a “daisy chain” fashion. For example, during a first training stage, a first encoder and a first decoder for a first domain and a second encoder and a second decoder for a second domain could be trained using the technique described above to learn a shared latent space between the two domains. During a second training stage, a third encoder for a third domain could be paired with the first and/or second decoder, and a third decoder for the third domain could be paired with the first and/or second encoder. The same training technique could be repeated using the new encoder-decoder pairs so that the latent space associated with the third domain is shared with the latent spaces of the first and second domains. Additional training stages could further be added to extend the shared latent space to additional domains.

One technical advantage of the disclosed techniques relative to the prior art is that the shared latent space learned by the machine learning model allows disparate types of data to be related to one another in a semantically meaningful manner. Accordingly, the disclosed techniques provide a more complete view of a biological system (or another type of entity) that is represented using these types of data than conventional machine learning techniques that are not capable of generating shared latent spaces across multiple biological (or other types of) domains. Another technical advantage of the disclosed techniques is the ability to train the machine learning model to learn the shared latent space in the absence of paired training data from different domains. Consequently, the disclosed techniques can use a larger set of data to generate a more complete and semantically meaningful shared latent space than prior art approaches that use paired data to learn latent spaces associated with multiple domains. These technical advantages provide one or more technological improvements over prior art approaches.
1. In some embodiments, a computer-implemented method for determining a latent space between two domains comprises executing a first generator neural network to convert a first set of training data associated with a first domain into a first set of training outputs based on a first set of latent values associated with the first domain; executing a second generator neural network to convert the first set of training outputs into a second set of training outputs based on a second set of latent values associated with a second domain; and training the first generator neural network based on a first set of losses computed between the first set of latent values and the second set of latent values.

In various embodiments, the training data can be generated by any number of data generation steps, such as imaging, sequencing, -omics measurements, and generative machine learning. Examples of imaging techniques include light microscopy or cryogenic electron microscopy. Examples of -omics measurements include transciptomics (e.g., RNAseq), genomics, proteomics, metabolomics, and epigenomics (e.g., ATACseq, DNA methylation). Further, the training data may be perturbed in a variety of ways. Examples of perturbations include (i) environmental stimuli, such as temperature change, osmotic shock, pressure change, stress, starvation, (ii) perturbation with chemical, pharmaceutical, or biologic agent, (iii) manipulation of gene function, such as gene knockout (e.g., CRISPR knockout), transcript knockdown, or CRISPR alteration.
2. The computer-implemented method of clause 1, further comprising executing a discriminator neural network to convert the first set of latent values into a first set of predictions; executing the discriminator neural network to convert the second set of latent values into a second set of predictions; and computing the first set of losses based on the first set of predictions and the second set of predictions.
3. The computer-implemented method of any of clauses 1-2, wherein the first set of losses comprise a binary cross-entropy loss.
4. The computer-implemented method of any of clauses 1-3, further comprising training the second generator neural network based on a second set of losses computed between a third set of latent values generated by the first generator neural network and a fourth set of latent values generated by the second generator neural network.
5. The computer-implemented method of any of clauses 1-4, further comprising training the first generator neural network based on a second set of losses computed between the second set of training outputs and the first set of training data.
6. The computer-implemented method of any of clauses 1-5, further comprising executing the second generator neural network to convert a second set of training data into a third set of training outputs; executing the first generator neural network to convert the third set of training outputs into a fourth set of training outputs; and training at least one of the first generator neural network or the second generator neural network based on a second set of losses computed between the fourth set of training outputs and the second set of training data.
7. The computer-implemented method of any of clauses 1-6, further comprising training the second generator neural network based on a third set of losses computed between the third set of training outputs and the first set of training data.
8. The computer-implemented method of any of clauses 1-7, further comprising training the first generator neural network based on a second set of losses computed between the first set of training outputs and a third set of training data associated with the second domain.
9. The computer-implemented method of any of clauses 1-8, further comprising training at least one of the first generator neural network or the second generator neural network based on a second set of losses computed using a set of classifier predictions associated with the first set of training outputs.
10. The computer-implemented method of any of clauses 1-9, wherein at least one of the first domain or the second domain comprises at least one of image-based data, sequencing-based data, omics data, physiological data, steady-state cell data, perturbed cell data, young cell data, or old cell data.
11. In some embodiments, one or more non-transitory computer-readable media store instructions that, when executed by one or more processors, cause the one or more processors to perform the steps of executing a first generator neural network to convert a first set of training data associated with a first domain into a first set of training outputs based on a first set of latent values associated with the first domain; executing a second generator neural network to convert the first set of training outputs into a second set of training outputs based on a second set of latent values associated with a second domain; and training the first generator neural network based on a first set of losses computed between the first set of latent values and the second set of latent values.
12. The one or more non-transitory computer-readable media of clause 11, wherein the instructions further cause the one or more processors to perform the steps of executing a discriminator neural network to generate a first set of predictions associated with the first set of latent values; executing the discriminator neural network to generate a second set of predictions associated with the second set of latent values; and computing the first set of losses based on the first set of predictions and the second set of predictions.
13. The one or more non-transitory computer-readable media of any of clauses 11-12, wherein the instructions further cause the one or more processors to perform the steps of executing a discriminator neural network to generate a first set of predictions associated with the first set of training outputs; executing the discriminator neural network to generate a second set of predictions associated with a second set of training data in the second domain; and training the first generator neural network based on a second set of losses computed using the first set of predictions and the second set of predictions.
14. The one or more non-transitory computer-readable media of any of clauses 11-13, wherein the instructions further cause the one or more processors to perform the steps of executing the second generator neural network to convert a second set of training data associated with the second domain into a third set of training outputs; executing the first generator neural network to convert the third set of training outputs into a fourth set of training outputs; and training at least one of the first generator neural network or the second generator neural network based on a second set of losses computed between the fourth set of training outputs and the second set of training data.
15. The one or more non-transitory computer-readable media of any of clauses 11-14, wherein the instructions further cause the one or more processors to perform the steps of executing a discriminator neural network to generate a first set of predictions associated with the third set of training outputs; executing the discriminator neural network to generate a second set of predictions associated with the first set of training data; and training the second generator neural network based on a third set of losses computed using the first set of predictions and the second set of predictions.
16. The one or more non-transitory computer-readable media of any of clauses 11-15, wherein the instructions further cause the one or more processors to perform the steps of executing a third generator neural network to convert the first set of training data into a third set of training outputs based on a third set of latent values associated with the first domain; executing a fourth generator neural network to convert the third set of training outputs into a fourth set of training outputs based on a fourth set of latent values associated with a third domain; and training at least one of the third generator neural network or the fourth generator neural network based on a second set of losses computed between the third set of latent values and the fourth set of latent values.
17. The one or more non-transitory computer-readable media of any of clauses 11-16, wherein the first generator neural network comprises a first encoder associated with the first domain and a first decoder associated with the second domain.
18. The one or more non-transitory computer-readable media of any of clauses 11-17, wherein the second generator neural network comprises a second encoder associated with the second domain and a second decoder associated with the first domain.
19. The one or more non-transitory computer-readable media of any of clauses 11-18, wherein at least one of the first generator neural network or the second generator neural network comprises a residual block with a rectified linear unit (ReLU) activation function.
20. In some embodiments, a system comprises one or more memories that store instructions, and one or more processors that are coupled to the one or more memories and, when executing the instructions, are configured to perform the steps of executing one or more components of a first generator neural network to convert between a first set of data associated with a first domain and a first set of latent values; executing one or more components of a second generator neural network to convert between a second set of data associated with a second domain and a second set of latent values, wherein the first generator neural network and the second generator neural network were trained using one or more losses computed between a third set of latent values associated with the first domain and a fourth set of latent values associated with the second domain; and generating one or more predictions based on the first set of latent values and the second set of latent values.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for determining a latent space between two or more domains, the method comprising:
executing a first generator neural network to convert a first set of training data associated with a first domain into a first set of training outputs based on a first set of latent values associated with the first domain;
executing a second generator neural network to convert the first set of training outputs into a second set of training outputs based on a second set of latent values associated with a second domain; and
training the first generator neural network based on a first set of losses computed between the first set of latent values and the second set of latent values.

2. The computer-implemented method of claim 1, further comprising:
executing a discriminator neural network to convert the first set of latent values into a first set of predictions;
executing the discriminator neural network to convert the second set of latent values into a second set of predictions; and
computing the first set of losses based on the first set of predictions and the second set of predictions.

3. The computer-implemented method of claim 2, wherein the first set of losses comprise a binary cross-entropy loss.

4. The computer-implemented method of claim 1, further comprising training the second generator neural network based on a second set of losses computed between a third set of latent values generated by the first generator neural network and a fourth set of latent values generated by the second generator neural network.

5. The computer-implemented method of claim 1, further comprising training the first generator neural network based on a second set of losses computed between the second set of training outputs and the first set of training data.

6. The computer-implemented method of claim 1, further comprising:
executing the second generator neural network to convert a second set of training data into a third set of training outputs;
executing the first generator neural network to convert the third set of training outputs into a fourth set of training outputs; and
training at least one of the first generator neural network or the second generator neural network based on a second set of losses computed between the fourth set of training outputs and the second set of training data.

7. The computer-implemented method of claim 6, further comprising training the second generator neural network based on a third set of losses computed between the third set of training outputs and the first set of training data.

8. The computer-implemented method of claim 1, further comprising training the first generator neural network based on a second set of losses computed between the first set of training outputs and a third set of training data associated with the second domain.

9. The computer-implemented method of claim 1, further comprising training at least one of the first generator neural network or the second generator neural network based on a second set of losses computed using a set of classifier predictions associated with the first set of training outputs.

10. The computer-implemented method of claim 1, wherein at least one of the first domain or the second domain comprises at least one of image-based data, sequencing-based data, omics data, physiological data, steady-state cell data, perturbed cell data, young cell data, or old cell data.

11. One or more non-transitory computer-readable media storing instructions that, when executed by one or more processors, cause the one or more processors to perform the steps of:
executing a first generator neural network to convert a first set of training data associated with a first domain into a first set of training outputs based on a first set of latent values associated with the first domain;
executing a second generator neural network to convert the first set of training outputs into a second set of training outputs based on a second set of latent values associated with a second domain; and
training the first generator neural network based on a first set of losses computed between the first set of latent values and the second set of latent values.

12. The one or more non-transitory computer-readable media of claim 11, wherein the instructions further cause the one or more processors to perform the steps of:
executing a discriminator neural network to generate a first set of predictions associated with the first set of latent values;
executing the discriminator neural network to generate a second set of predictions associated with the second set of latent values; and
computing the first set of losses based on the first set of predictions and the second set of predictions.

13. The one or more non-transitory computer-readable media of claim 11, wherein the instructions further cause the one or more processors to perform the steps of:
executing a discriminator neural network to generate a first set of predictions associated with the first set of training outputs;
executing the discriminator neural network to generate a second set of predictions associated with a second set of training data in the second domain; and
training the first generator neural network based on a second set of losses computed using the first set of predictions and the second set of predictions.

14. The one or more non-transitory computer-readable media of claim 11, wherein the instructions further cause the one or more processors to perform the steps of:
executing the second generator neural network to convert a second set of training data associated with the second domain into a third set of training outputs;
executing the first generator neural network to convert the third set of training outputs into a fourth set of training outputs; and
training at least one of the first generator neural network or the second generator neural network based on a second set of losses computed between the fourth set of training outputs and the second set of training data.

15. The one or more non-transitory computer-readable media of claim 14, wherein the instructions further cause the one or more processors to perform the steps of:
executing a discriminator neural network to generate a first set of predictions associated with the third set of training outputs;
executing the discriminator neural network to generate a second set of predictions associated with the first set of training data; and
training the second generator neural network based on a third set of losses computed using the first set of predictions and the second set of predictions.

16. The one or more non-transitory computer-readable media of claim 11, wherein the instructions further cause the one or more processors to perform the steps of:
executing a third generator neural network to convert the first set of training data into a third set of training outputs based on a third set of latent values associated with the first domain;
executing a fourth generator neural network to convert the third set of training outputs into a fourth set of training outputs based on a fourth set of latent values associated with a third domain; and
training at least one of the third generator neural network or the fourth generator neural network based on a second set of losses computed between the third set of latent values and the fourth set of latent values.

17. The one or more non-transitory computer-readable media of claim 11, wherein the first generator neural network comprises a first encoder associated with the first domain and a first decoder associated with the second domain.

18. The one or more non-transitory computer-readable media of claim 17, wherein the second generator neural network comprises a second encoder associated with the second domain and a second decoder associated with the first domain.

19. The one or more non-transitory computer-readable media of claim 11, wherein at least one of the first generator neural network or the second generator neural network comprises a residual block with a rectified linear unit (ReLU) activation function.

20. A system, comprising:
one or more memories that store instructions, and
one or more processors that are coupled to the one or more memories and, when executing the instructions, are configured to perform the steps of:
executing one or more components of a first generator neural network to convert between a first set of data associated with a first domain and a first set of latent values;
executing one or more components of a second generator neural network to convert between a second set of data associated with a second domain and a second set of latent values, wherein the first generator neural network and the second generator neural network were trained using one or more losses computed between a third set of latent values associated with the first domain and a fourth set of latent values associated with the second domain; and
generating one or more predictions based on the first set of latent values and the second set of latent values.
